(19) United States
(12) Patent Application Publication
(10) Pub. No.: US 2025/0119045 A1
(43) Pub. Date: Apr. 10, 2025

(54) DIRECT-DRIVE SYSTEM

(71) Applicant: AAC Microtech (Changzhou) Co., Ltd., Changzhou City, Jiangsu Province (CN)

(72) Inventors: Yu Qin, Shenzhen (CN); Weiling Shi, Shenzhen (CN); Shun Guo, Shenzhen (CN); Lin Qian, Shenzhen (CN)

(21) Appl. No.: 17/919,531

(22) PCT Filed: Jul. 20, 2022
(86) PCT No.: PCT/CN2022/106637

§ 371 Date: Oct. 18, 2022

(30) Foreign Application Priority Data
Jun. 30, 2022 (CN) 202221693954.1

(51) Int. Cl. H02K 41/03; H02K 5/10

(52) U.S. Cl. CPC H02K 41/031; H02K 5/10

(57) ABSTRACT

A direct-drive system, including: a base; a mover assembly arranged on the slide; a stator assembly arranged on the base; and at least one mover protective assembly fixed to the slide and in contact with the stator assembly. An electromagnetic force is formed between the mover assembly and the stator assembly to drive the slide to slide relative to the base; and in a direction perpendicular to a sliding direction of the slide, the mover assembly and the stator assembly are opposite to and spaced from each other to form a gap. The at least one mover protective assembly is configured to enclose the gap. The at least one mover protective assembly can enclose the gap between the mover assembly and the stator assembly, so as to effectively prevent foreign matters from entering a mover air gap and thus improving reliability of the system.

### TECHNICAL FIELD

The present invention belongs to the technical field of motors, and in particular, to a direct-drive system.

### BACKGROUND

For a direct-drive system in the related art, a mover has no protective structure. Due to an air gap between a mover magnet and a stator coil, foreign matters are easy to fall into the air gap, resulting in blockage and system breakdown.

With respect to the above problems, there is a need to provide a direct-drive system that is reasonably designed and can effectively alleviate the above problems.

### SUMMARY

The present invention aims to solve at least one of the technical problems existing in the related art and provides a direct-drive system.

An embodiment of the present invention provides a direct-drive system, including: a base; a slide arranged on the base; a mover assembly arranged on the slide; a stator assembly arranged on the base; and at least one mover protective assembly fixed to the slide and in contact with the stator assembly. An electromagnetic force is formed between the mover assembly and the stator assembly to drive the slide to slide relative to the base; and in a direction perpendicular to a sliding direction of the slide, the mover assembly and the stator assembly are opposite to and spaced from each other to form a gap. The at least one mover protective assembly is configured to enclose the gap.

As an improvement, the at least one mover protective assembly includes a fixed member and a protective member. The fixed member is fixed to the slide and at least partially extends between the slide and the stator assembly, the protective member is at least partially located between the slide and the stator assembly, and the protective member includes an end connected to the fixed member and another end in contact with the stator assembly.

As an improvement, the fixed member includes a fixed portion and a mounting portion. The fixed portion is fixed to an outer surface of the slide, and the mounting portion extends between the slide and the stator assembly and is provided with the protective member.

As an improvement, a mounting groove is provided at a side of the mounting portion away from the fixed portion, and the protective member is accommodated at the mounting groove.

As an improvement, the protective member is made of a flexible material.

As an improvement, the protective member is a protective brush.

As an improvement, the mover assembly includes a first mounting plate fixed to the slide and a magnet fixed to a side of the first mounting plate facing the stator assembly, and the stator assembly includes a second mounting plate fixed to the base and a coil fixed to the second mounting plate and spaced from the magnet. The at least one mover protective member is arranged at a periphery of the magnet and spaced from the magnet.

As an improvement, the slide includes a bottom plate slidable on the base, a top plate spaced from the bottom plate, and a side plate connecting the bottom plate and the top plate. The bottom plate, the side plate, and the top plate define a receiving space for receiving the coil. An outer side wall of the top plate is connected to the side plate, and other outer side walls of the top plate are each provided with the at least one mover protective assembly.

As an improvement, the magnet includes a first group of magnets arranged at a side of the top plate close to the bottom plate and a second group of magnets arranged at a side of the bottom plate close to the top plate, and the first group of magnets and the second group of magnets interact with the coil to drive the slide to slide relative to the base.

As an improvement, an outer side wall of the bottom plate is connected to the side plate, and other outer side walls of the bottom plate are each provided with the at least one mover protective assembly. The at least one mover protective assembly is arranged at a periphery of the second group of magnets and spaced from the second group of magnets.

According to the present invention, the direct-drive system includes at least one mover protective assembly fixed to the slide and in contact with the stator assembly, and the at least one mover protective assembly can enclose the gap between the mover assembly and the stator assembly, so as to effectively prevent foreign matters from entering a mover air gap and thus improving reliability of the system.

### BRIEF DESCRIPTION OF DRAWINGS

FIG. 1 is a schematic structural diagram of a direct-drive system according to an embodiment of the present invention;

FIG. 2 is a sectional view of a direct-drive system according to an embodiment of the present invention;

FIG. 3 is a partially enlarged view of a part A shown in FIG. 2;

FIG. 4 is a schematic structural diagram of a mover assembly according to an embodiment of the present invention; and

FIG. 5 is a schematic structural diagram of a mover assembly according to an embodiment of the present invention from another perspective.

### DESCRIPTION OF EMBODIMENTS

To enable those skilled in the art to better understand the technical solutions of the present invention, the present invention is described in detail below with reference to the accompanying drawings and embodiments.

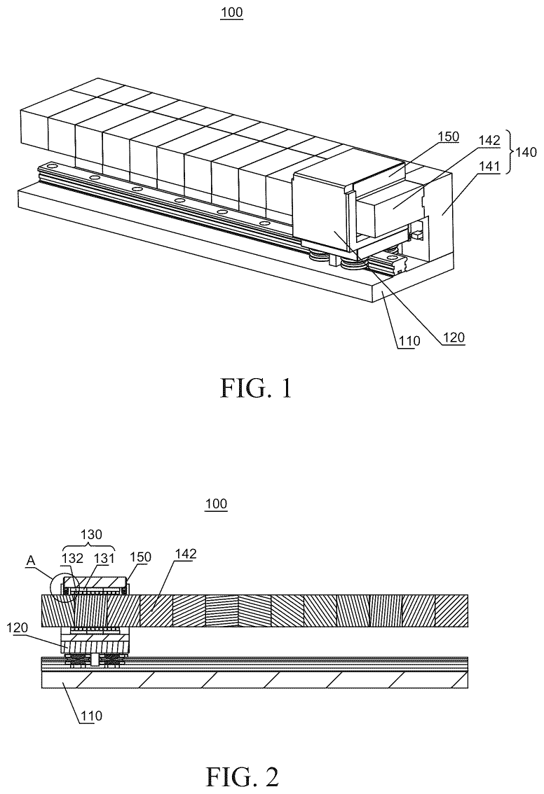

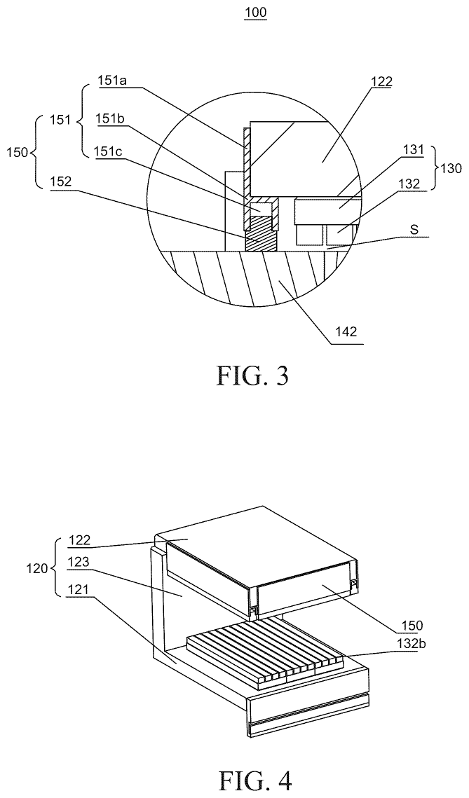

As shown in FIG. 1, FIG. 2, and FIG. 3, an embodiment provides a direct-drive system 100. The direct-drive system 100 includes a base 110, a slide 120, a mover assembly 130, and a stator assembly 140. The slide 120 is slidable on the base 110. The mover assembly 130 is arranged on the slide 120. The stator assembly 140 is arranged on the base 110. An electromagnetic force is formed between the mover assembly 130 and the stator assembly 140 to drive the slide 120 to slide relative to the base 110. in a direction perpendicular to a sliding direction of the slide 120, the mover assembly 130 and the stator assembly 140 are opposite to and spaced from each other to form a gap S.

In an embodiment, as shown in FIG. 2 and FIG. 3, the direct-drive system 100 further includes at least one mover protective assembly 150 for enclosing the gap S. The mover protective assembly 150 is fixed to the slide 120 and in contact with the stator assembly 140.

According to the direct-drive system in this embodiment, with the arrangement of one or more mover protective assemblies that are fixed to the slide and in contact with the stator assembly, the one or more mover protective assemblies can enclose the gap between the mover assembly and the stator assembly, thereby effectively preventing foreign matters from entering a mover air gap and thus improving the reliability of the system.

For example, in order to facilitate mounting and effectively prevent foreign matters from entering the mover air gap, as shown in FIG. 2 and FIG. 3, the mover protective assembly 150 includes a fixed member 151 and a protective member 152. The fixed member 151 is fixed to the slide 120 and at least partially extends between the slide 120 and the stator assembly 140. The protective member 152 is at least partially located between the slide and the stator assembly, and the protective member 152 includes an end connected to the fixed member 151 and another end in contact with the stator assembly 140.

In an embodiment, as shown in FIG. 3, the fixed member 151 includes a fixed portion 151a and a mounting portion 151b, the fixed portion 151a is fixed to an outer surface of the slide 120, and the mounting portion 151b extends between the slide 120 and the stator assembly 140 and is provided with the protective member 152. In an example, as shown in FIG. 1, a mounting groove 151c may be provided at a side of the mounting portion 151b away from the fixed portion 151a, and the mounting groove 151c accommodates the protective member 152, so as to effectively simplify the mounting of the protective member 152. The protective member 152 may be inserted into the mounting groove 151c by bonding or other means, or the protective member 152 may be inserted into the mounting groove 151c by transition or interference fit, which is not limited in this embodiment.

For example, in order to avoid an influence of the mover protective assembly on motion of the mover, as shown in FIG. 3, the protective member 152 is made of a flexible material. In an example, the protective member 152 may be a protective brush. Certainly, in addition, the protective member 152 may also be made of some other flexible materials.

According to the direct-drive system of this embodiment, the protective member of the mover protective assembly is flexible and includes a tail end that can fit completely (or almost completely) with the stator, so as to prevent the foreign matters. In addition, friction between the flexible protective member and the stator is small, so the motion of the mover may not be greatly influenced.

For example, as shown in FIG. 1 and FIG. 2, the mover assembly 130 includes a first mounting plate 131 fixed to the slide 120 and a magnet 132 fixed to a side of the first mounting plate 131 facing the stator assembly 140. The stator assembly 140 includes a second mounting plate 141 fixed to the base 110 and a coil 142 fixed to the second mounting plate 141 and spaced from the magnet 132. The mover protective member 150 is arranged at a periphery of the magnet 132 and spaced from the magnet 132. In an example, the first mounting plate 131 and the second mounting plate 141 may be magnetically conductive plates.

In an example, as shown in FIG. 1 and FIG. 4, the slide 120 includes a bottom plate 121 slidable on the base 110, a top plate 122 spaced from the bottom plate 121, and a side plate 123 connecting the bottom plate 121 and the top plate 122. The bottom plate 121, the side plate 123, and the top plate 122 define a receiving space for receiving the coil 142. The side plate 123 is connected to an outer side wall of the top plate 122, and other outer side walls of the top plate 122 are each provided with the mover protective assembly 150. That is, as shown in FIG. 1, two side surfaces and a front surface of the top plate 122 are each provided with the mover protective assembly 150.

According to the direct-drive system in this embodiment, the mounting of the mover protective assembly on each of the two side surfaces and the front surface of the top plate plus the structure of the mover assembly can further effectively prevent foreign matters from entering the mover, so as to prevent blockage of the air gap between the magnet and the stator.

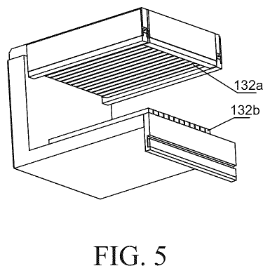

For example, as shown in FIG. 1 and FIG. 5, the magnet 132 includes: a first group of magnets 132a arranged at a side of the top plate 122 close to the bottom plate 121, and a second group of magnets 132b arranged at a side of the bottom plate 121 close to the top plate 122. The first group of magnets 132a and the second group of magnets 132b interact with the coil 142 to drive the slide 120 to slide relative to the base 110.

In an embodiment, the side plate 123 is connected to an outer side wall of the bottom plate 121, other outer side walls of the bottom plate 121 are each provided with the mover protective assembly 150, and the mover protective assembly 150 is arranged at a periphery of the second group of magnets 132b and spaced from the second group of magnets 132b.

It should be understood that the above embodiments are merely exemplary embodiments intended to illustrate the principle of the present invention, but the present invention is not limited thereto. For those of ordinary skill in the art, various variations and improvements can be made without deviating from the spirit and essence of the present invention, and all these variations and improvements shall fall within a scope of the present invention.

1. A direct-drive system, comprising:
a base;
a slide arranged on the base;
a mover assembly arranged on the slide;
a stator assembly arranged on the base; and
at least one mover protective assembly fixed to the slide and in contact with the stator assembly,
wherein an electromagnetic force is formed between the mover assembly and the stator assembly to drive the slide to slide relative to the base; and in a direction perpendicular to a sliding direction of the slide, the mover assembly and the stator assembly are opposite to and spaced from each other to form a gap; and
wherein the at least one mover protective assembly is configured to enclose the gap.

2. The direct-drive system as described in claim 1, wherein the at least one mover protective assembly comprises a fixed member and a protective member; wherein the fixed member is fixed to the slide and at least partially extends between the slide and the stator assembly, the protective member is at least partially located between the slide and the stator assembly, and the protective member comprises an end connected to the fixed member and another end in contact with the stator assembly.

3. The direct-drive system as described in claim 2, wherein the fixed member comprises a fixed portion and a mounting portion; wherein the fixed portion is fixed to an outer surface of the slide, and the mounting portion extends between the slide and the stator assembly and is provided with the protective member.

4. The direct-drive system as described in claim 3, wherein a mounting groove is provided at a side of the mounting portion away from the fixed portion, and the protective member is accommodated at the mounting groove.

5. The direct-drive system as descried in claim 2, wherein the protective member is made of a flexible material.

6. The direct-drive system as described in claim 5, wherein the protective member is a protective brush.

7. The direct-drive system as described in claim 1, wherein the mover assembly comprises a first mounting plate fixed to the slide and a magnet fixed to a side of the first mounting plate facing the stator assembly, and the stator assembly comprises a second mounting plate fixed to the base and a coil fixed to the second mounting plate and spaced from the magnet; and
wherein the at least one mover protective member is arranged at a periphery of the magnet and spaced from the magnet.

8. The direct-drive system as described in claim 7, wherein the slide comprises a bottom plate slidable on the base, a top plate spaced from the bottom plate, and a side plate connecting the bottom plate and the top plate; and
wherein the bottom plate, the side plate, and the top plate define a receiving space for receiving the coil; and wherein an outer side wall of the top plate is connected to the side plate, and other outer side walls of the top plate are each provided with the at least one mover protective assembly.

9. The direct-drive system as described in claim 8, wherein the magnet comprises a first group of magnets arranged at a side of the top plate close to the bottom plate and a second group of magnets arranged at a side of the bottom plate close to the top plate, and the first group of magnets and the second group of magnets interact with the coil to drive the slide to slide relative to the base.

10. The direct-drive system as described in claim 9, wherein an outer side wall of the bottom plate is connected to the side plate, and other outer side walls of the bottom plate are each provided with the at least one mover protective assembly; and wherein the at least one mover protective assembly is arranged at a periphery of the second group of magnets and spaced from the second group of magnets.
